(19) United States
(12) Patent Application Publication
(10) Pub. No.: US 2014/0090371 A1
(43) Pub. Date: Apr. 3, 2014

(54) ELECTRIC MOTOR-DRIVEN BOOSTER

(71) Applicant: HITACHI AUTOMOTIVE SYSTEMS, LTD., Ibaraki (JP)

(72) Inventors: Rikiya YOSHIZU, Kanagawa (JP); Takuya USUI, Kanagawa (JP); Atsushi ODAIRA, Kanagawa (JP)

(73) Assignee: HITACHI AUTOMOTIVE SYSTEMS, LTD., Ibaraki (JP)

(21) Appl. No.: 14/033,573

(22) Filed: Sep. 23, 2013

(30) Foreign Application Priority Data
Sep. 28, 2012 (JP) 216305/2012

(51) Int. Cl. B60T 13/74

(52) U.S. Cl. CPC B60T 13/745
USPC 60/545

(57) ABSTRACT

An electric motor is controlled according to an operation of a brake pedal connected to an input rod to drive a ball-screw mechanism through a transmission mechanism, thereby propelling a primary piston and a subpiston to generate brake hydraulic pressure in a master cylinder. The brake hydraulic pressure in the master cylinder is received with an input piston and transmitted to the brake pedal through a plunger rod and the input rod. The input rod and the plunger rod are tiltably connected, through a ball joint, and the plunger rod is axially slidably guided by a guide part of a rear cover. Thus, a lateral force acting on the primary piston or the subpiston is reduced to prevent an increase in sliding resistance and degradation of sealing performance.

### BACKGROUND OF INVENTION

The present invention relates to boosters incorporated in brake systems of automobiles and other vehicles, and, more particularly, to an electric motor-driven booster generating brake hydraulic pressure by driving a piston in a master cylinder with an electric motor according to an amount of operation of a brake pedal.

A publicly known electric motor-driven booster is disclosed, for example, in Japanese Patent Application Publication No. 2012-35814. With the electric motor-driven booster, an electric motor is controlled by a controller according to an amount of driver's operation of a brake pedal, and the rotary motion of the electric motor is converted into a rectilinear motion through a ball-screw mechanism, which is a rotation-rectilinear motion conversion mechanism, to propel a piston in a master cylinder, thereby generating brake hydraulic pressure. Further, an input piston connected to the brake pedal is inserted into the master cylinder to transmit the brake hydraulic pressure in the master cylinder to the brake pedal.

The electric motor-driven booster, in which the input piston connected to the brake pedal is inserted into the master cylinder, as stated above, suffers from the following drawbacks.

The input piston is moved to advance and retract in response to the driver's brake pedal operation directly through an input rod connected to the brake pedal. Accordingly, if the input rod is caused to tilt slightly by the operation of the brake pedal, a lateral force acts on the piston in the master cylinder. The lateral force acting on the master cylinder piston causes an increase in sliding resistance, degradation of sealing performance, and seal wear.

### SUMMARY OF INVENTION

An object of the present invention is to provide an electric motor-driven booster configured to reduce a lateral force acting on the piston in the master cylinder.

To solve the above-described problem, the present invention, provides an electric motor-driven booster comprising a housing to which a master cylinder is connected, an electric motor provided in the housing and operating in response to an operation of a brake pedal, a rectilinear motion member provided, in the housing and driven by the electric motor to propel a piston in the master cylinder, and an input member abuttable against the piston in the master-cylinder and movable in response to the operation of the brake pedal to transmit a reaction force from brake hydraulic pressure in the master cylinder to the brake pedal. The input member includes a plunger rod for transmitting the reaction force from the brake hydraulic pressure in the master cylinder, and an input rod tiltably connected at one end thereof to the plunger rod, the other end of the input rod being connected to the brake pedal. The electric motor-driven booster is provided with a guide part axially movably guiding the plunger rod relative to the housing.

### BRIEF DESCRIPTION OF DRAWINGS

FIG. 1 is a side view of an electric motor-drivers booster according to one embodiment of the present invention.

FIG. 2 is a vertical sectional view of the electric motor-driven booster shown in FIG. 1.

FIG. 3 is an exploded perspective view of an important part of the electric motor-driven booster shown in FIG. 1.

### DESCRIPTION OF EMBODIMENTS

One embodiment of the present invention will be explained below in detail with reference to the accompanying drawings.

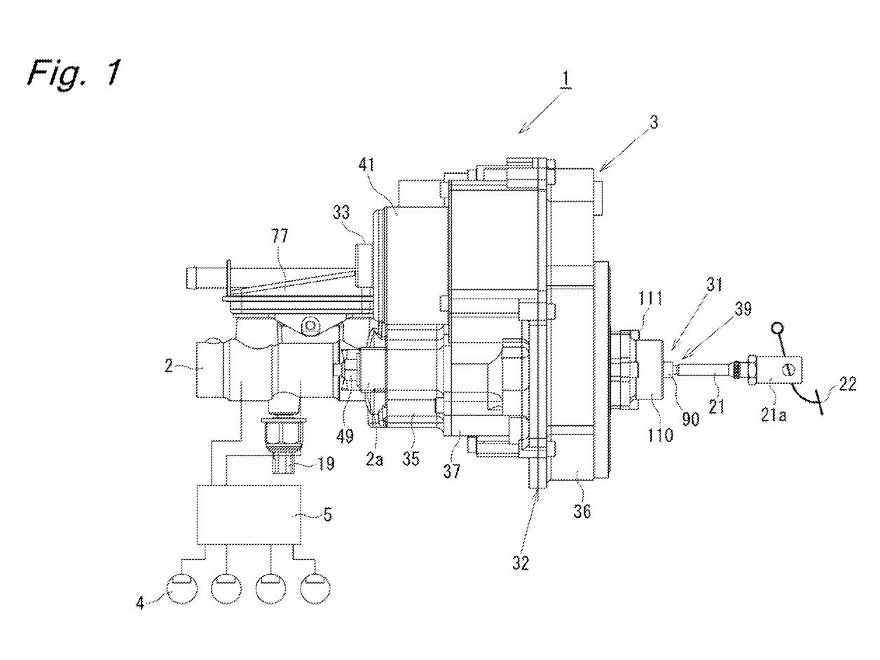

FIG. 1 shows a brake system of an automobile incorporating an electric motor-driven booster according to this embodiment. As shown in FIG. 1, the brake system 1 has a master cylinder 2 for generating brake hydraulic pressure, and an electric motor-driven booster 3 connected to the master cylinder 2 as one unit to propel a primary piston 72 (piston) in the master cylinder 2. The brake system 1 further has hydraulic wheel cylinders 4 connected to the master cylinder 2 and supplied with, the brake hydraulic pressure to generate a braking force for each wheel. Further, the brake system 1 has a hydraulic pressure control unit 5 interposed between the master cylinder 2 and the wheel cylinders 4, and an in-vehicle controller (not shown) for controlling the operations of the electric motor-driven booster 3 and the hydraulic pressure control unit 5.

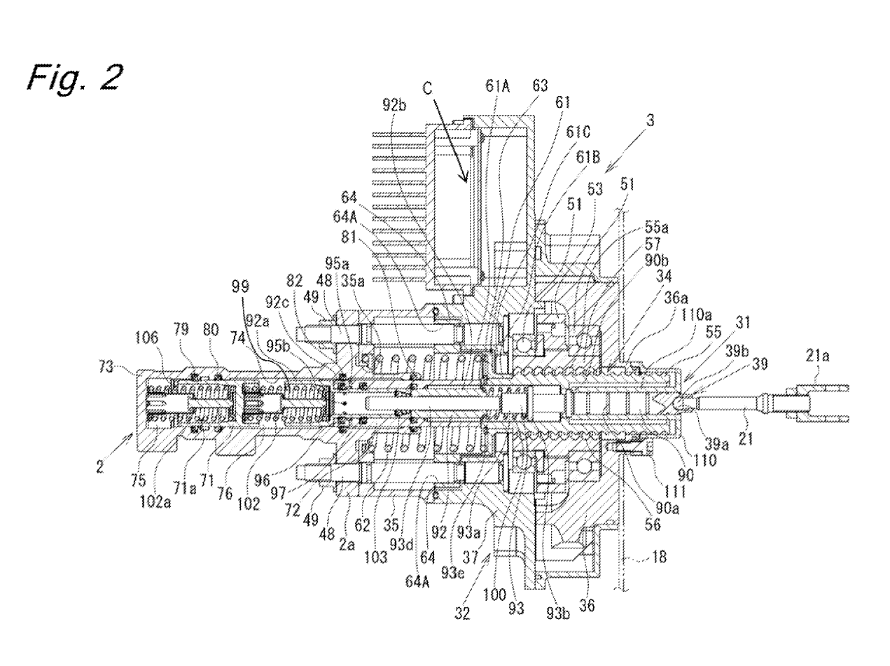

As shown in FIG. 2, the electric motor-driven booster 3 has an input member 31, an electric motor 33 (see FIG. 1), a ball-screw mechanism 34, which is a rotation-rectilinear motion conversion mechanism, a housing 32 accommodating these components, and a controller C integrally secured to the housing 32.

The housing 32 is formed of an aluminum alloy or the like and has a three-segment structure. That is, the housing 32 has a front housing member 35 located closer to the master cylinder 2, a rear housing member 36 closer to a brake pedal 22 (see FIG. 1), and an intermediate housing member 37 connected between the front and rear housing members 35 and 36.

The front housing member 35 is in the shape of a bottomed substantially circular cylinder having an opening 35a provided in the bottom thereof. The front housing member 35 has an opening-side end of the master cylinder 2 inserted therein through the opening 35a. The intermediate housing member 37 is connected, with a motor casing 41 (see FIG. 1) disposed at a side of the front housing member 35. The intermediate housing member 37 cooperates with the motor casing 41 to accommodate the electric motor 33. Further, the intermediate housing member 37 has proximal end portions of a pair of through-bolts 48 press-fitted and secured thereto. The through-bolts 48 are disposed at respective positions facing each other in the diametric direction of the intermediate housing member 37. The intermediate housing member 37, the front housing member 35 and the master cylinder 2 are connected together as one unit by inserting the through-bolts 48 through the bottom of the front housing member 35 and through a mounting portion 2a of the master cylinder 2 and screwing nuts 49 onto the distal ends of the through-bolts 48. The rear housing member 36 is connected to the other end of the intermediate housing member 37. The rear housing member 36 is secured at the rear end thereof to a dash panel 18 serving as a partition between an engine room and compartment of the vehicle. The rear housing member 36 has a cylindrical portion 36a projecting from the rear end thereof. The cylindrical portion 36a extends into the compartment through the dash panel. 18. A rear cover 110 in the shape of a substantially bottomed circular cylinder is secured to the cylindrical portion 36a with a bolt 111.

The housing 32 has the input member 31 inserted thereinto. The input member 31 extends axially into the master cylinder 2 from the outside of the rear cover 110 secured to the cylindrical portion 36a of the rear housing member 86. The input member 31 has an input rod 21, a plunger rod 90, and an input piston 93. The input rod 21 is connected to the brake pedal 22 (see FIG. 1) through a clevis 21a attached to the proximal end of the input rod 21.

The proximal end of the plunger rod 90 and the distal end of the input rod 21 are connected through a ball joint 39. The ball joint 39 has a ball, socket 39a formed at the proximal end of the plunger rod 90 and a ball 39b formed at the distal end of the input rod 21. By fitting the ball 39b into the ball socket 39a, the plunger rod 90 and the input rod 21 are pivotally connected (pivot joint) to each other, thereby permitting relative tilting between the plunger rod 90 and the input rod 21. The input piston 93 abuts at its proximal end against the distal end of the plunger rod 90. The distal end of the input piston 93 extends into the master cylinder 2 through a subpiston 92.

The subpiston 92 is in the shape of a stepped cylinder having a large-diameter spring retaining portion 92a at the front end side thereof and a small-diameter piston portion 92b at the rear end side thereof. The piston portion 92b is slidably and liquid-tightly fitted with a small-diameter portion 93d at the distal end of the input piston 93. The spring retaining portion 92a of the subpiston 92 is disposed in the master cylinder 2. The piston portion 92b of the subpiston 92 is liquid-tightly and slidably fitted in a cylindrical primary piston 72.

The subpiston 92 has a stepped portion 92c provided between the spring retaining portion 92a and the piston portion 92b. The distal end of the primary piston 72 is abutting against the stepped portion 92c.

The substantially bottomed circular cylindrical rear cover 110 has a double-tube structure. The rear cover 110 has a bottom at a side thereof closer to the input rod 21. An axially extending small-diameter circular cylindrical guide part 110a is integrally formed in the center of the bottom of the rear cover 110. The rear cover 110 is in the shape of a cylinder. The guide part 110a extends to project from the opening end of a rear side wall of the cylindrical rear cover 110. In a state where the rear cover 110 is secured to the cylindrical portion 36a of the rear housing member 36 with the bolt 111, the guide part 110a extends toward the inside of the housing 32 through the cylindrical portion 36a.

The plunger rod 90 is inserted into the guide part 110a of the rear cover 110. The plunger rod 90 is axially slidably guided and supported by the guide part 110a so as not to move radially and not to tilt.

The plunger rod 90 has a plurality of outer peripheral grooves 90a formed on a surface thereof that is in sliding contact with the guide part 110a, thereby enhancing the scalability and slidability between the plunger rod 90 and the guide part 110a. The plunger rod 90 has a large-diameter flange portion 90b formed on an intermediate part thereof. The retract position of the plunger rod 90 is determined by abutment of the flange portion 90b against the distal end of the guide part 110a.

The input piston 93 has a stepped configuration having a small-diameter portion 93d at the distal end of the input piston 91, a medium-diameter portion 93a at the proximal end of the input piston 93, and a large-diameter flange portion 93b formed on the medium-diameter portion 93a. A stepped portion 93e is provided between the small-diameter portion 93d and the medium-diameter portion 93a. The stepped portion 93e is abuttable against the rear end of the subpiston 92. In addition, a reaction force adjusting spring 100 is interposed between the rear end of the subpiston 92 and the flange portion 93b. The reaction force adjusting spring 100 is a compression coil spring. The reaction force adjusting spring 100 adjusts a pedal reaction force applied to the brake pedal 22 when the input piston 93 and the subpiston 92 are displaced relative to each other.

In this embodiment, the piston in the master cylinder comprises the primary piston 72 and the subpiston 92. The input piston 93, which is a part of the input member, is abuttable against the piston in the master cylinder in both the axial and radial directions.

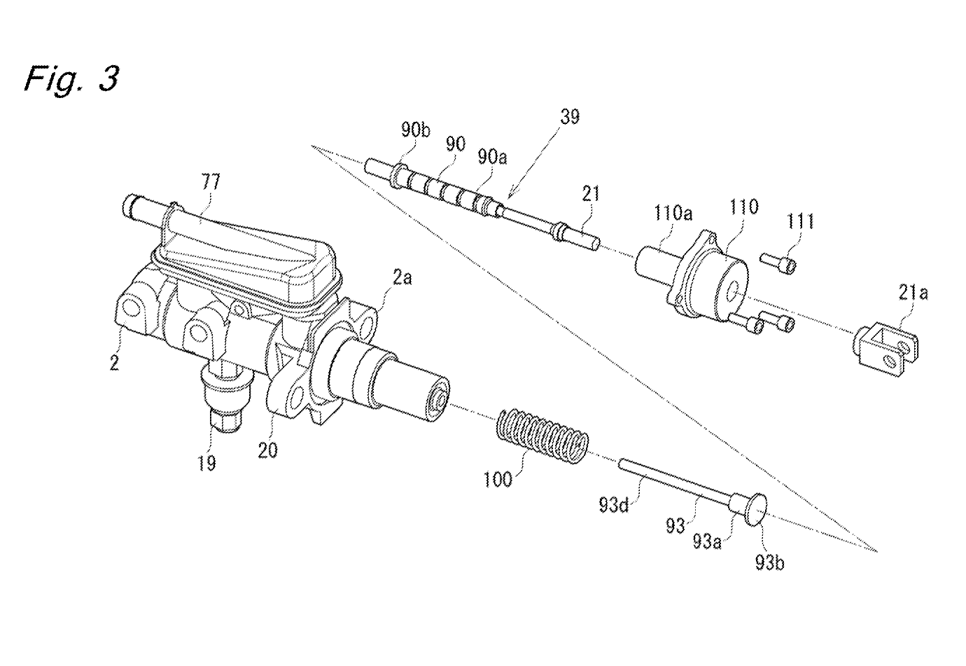

FIG. 3 is an exploded perspective view of the master cylinder 2, the reaction force adjusting spring 100, the input piston 93, the plunger rod 90, the input rod 21, the rear cover 110, and the clevis 21a.

The electric motor 33 is a brushless DC motor operated by a control electric current from the controller C to drive the ball-screw mechanism 34 through a transmission mechanism 53 comprising a belt, etc. The rotation of the electric motor 33 is detected by a rotation detector (not shown), e.g. a resolver, a rotary encoder, or Hall element, and the resulting detection signal is input to the controller C. The electric motor 33 may be a brushed DC motor, an AC motor, etc. in addition to the brushless DC motor used in this embodiment. It is, however, desirable to use a brushless DC motor from the viewpoint of controllability, silence, durability and so forth.

The ball-screw mechanism 34 has a cylindrical rectilinear motion member 55 disposed coaxially with the primary piston 72 in the master cylinder 2, a cylindrical rotating member 57 having the rectilinear motion member 55 inserted therein, and a plurality of balls 56 (steel spheres), which are rolling elements, loaded between spiral screw grooves 55a formed between, the rectilinear motion member 55 and the rotating member 57.

The rectilinear motion member 55 is inserted in the cylindrical portion 36a of the rear housing member 36 and also in the rear cover 110, which is secured to the cylindrical portion 36a, and supported axially movably bat non-rotatably about the axis. The rotating member 57 is supported by a pair of bearings 51 in the housing 32 rotatably about the axis but axially immovably. The ball-screw mechanism 34 rotates the rotating member 57 through the transmission mechanism 53 by the driving force of the electric motor 33, thereby allowing the balls 56 to roll in the screw grooves 55a, and thus causing the rectilinear motion member 55 to move axially.

A spring retainer 61 is connected to the front end of the rectilinear motion member 55 by a C-ring 63 in the front housing member 35. The spring retainer 61 is in the shape of a stepped cylinder having a large-diameter portion 61A, a small-diameter portion 61B, and a stepped portion 61C formed between the large- and small-diameter portions 61A and 61B. The large-diameter portion 61A has a pair of diametrically projecting guide portions 64 integrally formed on the outer periphery thereof.

The spring retainer 61 has the front end of the rectilinear motion member 55 inserted in the small-diameter portion 61B. The C-ring 63 is fitted to the distal end of the rectilinear motion member 55. With this structure, the spring retainer 61 is axially locked to the rectilinear motion member 55.

Further, the spring retainer 61 is connected to the rectilinear motion member 55 non-rotatably about the axis relative to the rectilinear motion member 55 by engagement between the small-diameter portion 61B and the front end of the rectilinear motion member 55.

For preventing relative rotation of the spring retainer 61 and the rectilinear motion member 55 about the axis, it is possible to use any publicly known anti-rotation detent structure, e.g. a recess-projection fitting, a spline fitting, a keyed fitting, or a double D cut anti-rotation fitting.

The through-bolts 48 are slidably fitted in guide holes 64A axially extending through the pair of guide portions 64. Thus, the spring retainer 61 is supported to the housing 32 axially movably but non-rotatably about the axis. In this way, the rectilinear motion member 55 is supported to the housing 32 through the spring retainer 61 axially movably but non-rotatably about the axis.

A return spring 62 is interposed between the bottom of the front housing member 35 and the spring retainer 61. The return spring 62 is a compression coil spring. The retract position of the rectilinear motion member 55 is determined by abutment of the stepped portion 61C of the spring retainer 61 against the intermediate housing member 37, which is caused by the spring force of the return spring 62. The rectilinear motion member 55 is returned to the retract position by the spring force of the return spring 62 when the driving force of the electric motor 33 does not act on the rectilinear motion member 55. In the rectilinear motion member 55, the plunger rod 90 and input piston 93 of the input member 31 are movably disposed.

As the transmission mechanism 53 of the electric motor 33, it is possible to use any publicly known transmission mechanism, such as a belt transmission mechanism, e.g. a toothed belt, a V-belt, a metal belt, and a resin belt, a gear transmission mechanism, or a chain transmission mechanism. Alternatively, the rotating member 57 may be driven directly by the electric motor 33 without using a transmission mechanism (i.e. by direct drive). It is also possible to combine a belt transmission mechanism with a speed reduction mechanism, e.g. a gear speed reduction mechanism, to thereby adjust the speed reduction ratio. Further, it is also possible to provide another transmission mechanism, e.g. a gear speed reduction mechanism, together with a belt transmission mechanism, as a backup in case the belt is cut off, for example.

The master cylinder 2 is a tandem master cylinder having a bottomed cylinder-shaped cylinder body 73 having a cylinder bore 74 therein. A circular cylindrical primary piston 72 and a bottomed cylindrical secondary piston 71 are disposed in the cylinder bore 74 in series in the axial direction. A primary chamber 76 is formed between the primary piston 72 and the secondary piston 71 in the cylinder bore 74. A secondary chamber 75 is formed between the secondary piston 71 and the bottom of the cylinder body 73. The primary piston 72 has the subpiston 92 inserted therein slidably and liquid-tightly. The subpiston 92 has the small-diameter portion 93d of the input piston 93 inserted therein slidably and liquid-tightly. The front end of the primary piston 72 abuts against the stepped portion 92c between the spring retaining portion 92a and piston portion 92b of the subpiston 92. A clearance is defined between the outer periphery of the spring retaining portion 92a and the cylinder bore 74.

The top of the side wall of the cylinder body 73 is provided with reservoir ports (not shown) communicating with the primary chamber 76 and the secondary chamber 75, respectively. These reservoir ports are connected to a reservoir 77 (see FIG. 1) storing a brake fluid. The cylinder bore 74 of the cylinder body 73 is provided with a pair of piston seals 81 and 82 and another pair of piston seals 79 and 80. The piston seals 81 and 82 are disposed to face each other in the axial direction across the reservoir port communicating with the primary chamber 76. The piston seals 79 and 80 are disposed to face each other in the axial direction across the reservoir port communicating with the secondary chamber 75. The piston seals 81 and 82 seal between the cylinder bore 74 and the primary piston 72. The piston seals 79 and 80 seal between the cylinder bore 74 and the secondary piston 71. The primary piston 72 has a piston port 95a radially extending through the side wall thereof. Similarly, the secondary piston 71 has a piston port 71a radially extending through the side wall of a circular cylindrical portion thereof.

The primary piston 72 has inner peripheral grooves fitted with a pair of piston seals 96 and 97 facing each other in the axial direction across the piston port 95a, to seal between the primary piston 72 and the subpiston 92. The subpiston 92 has a piston port 95b radially extending through the side wall thereof.

A piston seal 103 is fitted to the inner periphery of the subpiston 92 to seal between the subpiston 92 and the small-diameter portion 93d of the input piston 93. The piston seal 103 is disposed closer to the rear end of the subpiston 92 than the piston port 95b. The piston port 95b constantly communicates with the primary chamber 76 regardless of the position of the input piston 93.

The primary chamber 76 has a return spring 99 interposed between the secondary piston 71 and the subpiston 92. The return spring 99 is a compression coil spring. The return spring 99 urges the primary piston 72 and the subpiston 92 toward the respective retract positions by the spring force thereof, thereby causing the stepped portion 92c of the subpiston 92 to abut against the front end of the primary piston 72. The return spring 99 has an expandable retainer 102 inserted therein. The retainer 102 retains the return spring 99 in a predetermined compressed state. The retainer 102 is compressible against the spring force of the return spring 99.

The secondary chamber 75 has a return spring 106 interposed, between the bottom of the cylinder body 73 and the secondary piston 71. The return spring 106 urges the secondary piston 71 toward the retract position by the spring force thereof. The return spring 106 has an expandable retainer 102a inserted therein. The retainer 102a retains the return spring 106 in a predetermined compressed state. The retainer 102a is compressible against the spring force of the return spring 106.

When the primary and secondary pistons 72 and 71 and the subpiston 92 are at the respective retract positions, the piston port 95a of the primary piston 72 is disposed between the pair of piston seals 81 and 82, and the piston port 95b of the subpiston 92 is disposed between the pair of piston seals 96 and 97. At this time, the reservoir 77 and the primary chamber 76 are communicated with each other through the reservoir port. The piston port 71a of the secondary piston 71 is disposed between the pair of piston seals 79 and 80. At this time, the reservoir 77 and the secondary chamber 75 are communicated with each other through the reservoir port and the piston port 71a. Thus, it is possible to cope with wear of the brake pads and so forth by properly supplying the brake fluid from the reservoir 77 to the primary chamber 76 and the secondary chamber 75 so as to supplement the wheel cylinders 4 with additional brake fluid.

When the primary piston 72 and the subpiston 92 advance so that the piston port 95a of the primary piston 72 passes beyond the piston seal 82, the communication between the reservoir port and the piston port 95a is cut oft by the piston seal 82. Similarly, when the secondary piston 71 advances so that the piston port 71a thereof passes beyond the piston seal 79, the communication between the reservoir port and the piston port 71a is cut off by the piston seal 79. Consequently, the primary chamber 76 and the secondary chamber 75 are cut off from the reservoir 77. Accordingly, the primary chamber 76 and the secondary chamber 75 are pressurized as the primary and secondary pistons 72 and 7.1 advance.

When the primary piston 72 is at the retract position and the subpiston 92 advances together with the input piston 93 so that the piston port 95b of the subpiston 92 passes beyond the piston seal 96 of the primary piston 72, the piston port 95a of the primary piston 72 is cut off from the primary chamber 76 by the piston seal 96. Consequently, the communication between the primary chamber 76 and the reservoir 77 is cut off, and the primary chamber 76 is pressurized as the input piston 9.3 and the subpiston 92 advance.

With respect to the primary chamber 76, the pressure-receiving area A of the primary piston 72 is defined by the piston seal 82, which is on the outer peripheral side of the primary piston 72, and the piston seal 96, which is on the inner peripheral side thereof. The pressure-receiving area B of the subpiston 92 is defined by the piston seal 96, which is on the outer peripheral side of the subpiston 92, and the piston seal 103, which is on the inner peripheral side thereof. The pressure-receiving area C of the input piston 93 is defined by the piston seal 103, which is on the outer peripheral side of the input piston 93. The relationship between, the pressure-receiving areas A, B and C of the primary piston 72, the subpiston 92 and the input piston 93 is A>B>C.

The primary chamber 76 and the secondary chamber 75 are connected to the wheel cylinders 4 of the hydraulic brakes for the wheels by hydraulic circuits of two systems through the hydraulic pressure control unit 5. The use of the two-system hydraulic circuits has the advantage that, even if either one of the hydraulic circuits should fail, the braking function can be maintained by the other hydraulic circuit.

The electric motor-driven booster 3 is provided with various sensors including a stroke sensor (not shown) for detecting the amount of operation of the brake pedal 22, a rotation detector for detecting the rotation of the electric motor 33, a current sensor (not shown) for detecting an electric current (motor current) flowing through the electric motor 33, and a hydraulic pressure sensor 19 for detecting brake hydraulic pressure in the master cylinder 2. The controller C and the in-vehicle controller are supplied with electric power from an in-vehicle power supply to control the electric motor 33 on the basis of data detected by the above-described various sensors.

The hydraulic pressure control unit 5 has an electric motor-driven pump and electromagnetic control valves such as pressure increasing valves and pressure reducing valves and executes, under the control of the in-vehicle controller, a pressure reducing mode for reducing the hydraulic pressure to be supplied to the wheel cylinders 4 of the wheels, a pressure maintaining mode for maintaining the hydraulic pressure, and a pressure increasing mode for increasing the hydraulic pressure. Thus, it is possible to perform various brake control operations, such as braking force distribution control to appropriately distribute braking force to each wheel, anti-lock brake control, vehicle stability control to stabilise behavior of the vehicle through suppression of understeer and oversteer, hill start assist control, traction control, vehicle following control to maintain a predetermined distance between the vehicle concerned and a vehicle ahead, lane deviation avoidance control to keep the vehicle in the driving lane, and obstacle avoidance control.

Next, the operation of this embodiment arranged as stated above will be explained.

It should be noted that, in the master cylinder 2, when the primary chamber 76 is pressurized, the secondary chamber 75 is also pressurised through the secondary piston 71; therefore, only the operations of the primary chamber 76 and the constituent elements associated therewith will be explained in the following description.

(Non-Braking Mode)

When the system, is in a non-braking state, as shown in FIG. 2, the primary piston 72, together with the rectilinear motion member 55 of the ball-screw mechanism 34, is held in the retract position by the spring force of the return spring 62. The subpiston 92 is in the retract position determined by abutment of the stepped portion 92c against the front end of the primary piston 72, which is caused by the spring forces of the return springs 99 and 106. The input piston 93 is in the retract position determined by abutment thereof against the plunger rod 90, which is caused by the spring force of the reaction force adjusting spring 100, and by abutment of the flange portion 90b of the plunger rod 90 against the guide part 110a of the rear cover 110. In the non-braking state, the reservoir 77 and the primary chamber 76 are in communication with each other through the reservoir port and the piston ports 95a and 95b. Therefore, the primary chamber 76 is placed under the atmospheric pressure.

(Normal Braking Mode)

When the brake pedal 22 is operated to advance the input piston 93 through the input rod 21 and the plunger rod 90, the displacement of these members is detected by the stroke sensor. Upon receiving the detection signal from the stroke sensor, the controller C drives the electric motor 33 so that the primary piston 72 reaches a target position based on the displacement of the input member 31. The controller C feedback-controls the rotation of the electric motor 33 according to a detection signal from, the rotation detector. It should foe noted that the electric motor 33 may be controlled on the basis of detection made, for example, by a displacement sensor (not shown) detecting the position of the rectilinear motion member 55 or by the hydraulic pressure sensor 19 detecting the hydraulic pressure in the master cylinder 2 in place of the rotation detector.

The rotation of the electric motor 33 drives the rotating member 57 of the ball-screw mechanism 34 to rotate through the transmission mechanism 53, causing the rectilinear motion member 55 to advance, propelling the primary piston 72. At this time, the subpiston 92 advances together with the primary piston 72 because the stepped portion 92c of the subpiston 92 is abutting against the front end of the primary piston 72. Consequently, the primary chamber 76 of the master cylinder 2 is pressurized by the input piston 93 (pressure-receiving area C), the primary piston 72 (pressure-receiving area A) and the subpiston 92 (pressure-receiving area B). Brake hydraulic pressure generated in the master cylinder 2 is supplied to the hydraulic pressure control unit 5 through the pipelines of the two systems and further supplied to the wheel cylinders 4 of the wheels to generate braking force.

The hydraulic pressure in the primary chamber 76 of the master cylinder 2 is fed back as a reaction force to the brake pedal 22 through the input piston 93 (pressure-receiving area C). The feedback of the reaction force allows the basic input-output characteristics of the brake system. 1 to foe determined on the basis of the ratio of the pressure-receiving area C of the input piston 93 to the sum total of the pressure-receiving areas A, B and C of the primary piston 72, the subpiston 92 and the input piston 93. Further, the input-output characteristics can be controlled by adjusting the relative positions of the input piston 93, the primary piston 72 and the subpiston 92 to thereby adjust the reaction force with respect to the input piston 93 (i.e. the brake pedal. 22) through the spring force of the reaction force adjusting spring 100. In this regard, the ratio of the output to the input is increased, by adjusting the position of the primary piston 72 forward relative to the input piston 93. The ratio of the output to the input is reduced toy adjusting the position of the primary piston 72 rearward relative to the input piston 93. Thus, it is possible to execute various brake control operations, such as boost control, brake assist control, vehicle stability control, inter-vehicle control, regenerative cooperative control, etc.

When the depression of the brake pedal 22 is canceled or released, the input piston 93, the primary piston 72 and the subpiston 92 retract to the respective retract positions. Consequently, the brake hydraulic pressure in the master cylinder 2 is canceled or released, and the hydraulic pressure in the wheel cylinders 4 is canceled, or released. Thus, the braking is canceled or released.

(Regenerative Braking Mode)

In regenerative cooperative control, regenerative braking is performed in which a dynamo is driven by the rotation of a wheel during braking to convert kinetic energy into electric power and to recover the latter. Curing the regenerative braking, the controller C controls the electric motor 33 to reduce the brake hydraulic pressure in the master cylinder 2 by an amount corresponding to the braking force generated by the regenerative braking to obtain a desired braking force corresponding to the amount of operation of the brake pedal 22. More specifically, when regenerative braking is to be performed, the controller C controls the electric motor 33 by setting so that the amount of advancement of the primary piston 72 by the electric motor 33 is smaller than during the normal braking by an amount corresponding to the reduction in the hydraulic pressure in the master cylinder 2, i.e. the target position, of the primary piston 72 is closer to the retract position (closer to the brake pedal 22) than during the normal braking. At this time, the distance between the rear end of the subpiston 92 and the flange portion 93b becomes smaller than during the normal braking. Accordingly, the spring force of the reaction force adjusting spring 100 acting on the input piston 93 becomes larger than during the normal braking to compensate for a reduction in the hydraulic pressure reaction force due to the reduction in the hydraulic pressure in the master cylinder 2, thereby appropriately adjusting the pedal operating force applied to the brake pedal 22.

(In Event of Boost Failure)

The following is an explanation of the operation of this embodiment in the event that the rectilinear motion member 55 of the ball-screw mechanism 34 cannot advance from, the retract position because of a failure in the controller C, the electric motor 33, or the ball-screw mechanism 34, for example, i.e. in the event of a boost failure.

In response to a driver's operation of the brake pedal 22, first, the input rod 21, the plunger rod 90, and the input piston 93 advance. In this case, the electric motor 33 cannot operate, and the rectilinear motion member 55 of the ball-screw mechanism 34 does not advance. Neither the primary piston 72 nor the subpiston 92 advances. Until the stepped portion 93e of the input piston 93 abuts against the rear end of the subpiston 92, the primary chamber 76 of the master cylinder 2 remains communicated with the reservoir 77 through the piston ports 95a and 95b; therefore, the master cylinder 2 does not generate brake hydraulic pressure.

When the stepped portion 93e of the input piston 93 abuts against the rear end of the subpiston 92 as a result of the input member 31 continuing to advance, the subpiston 92 moves together with the input piston 93. Consequently, the stepped portion 92c of the subpiston 92 separates from the front end of the primary piston 72, and the subpiston 92 advances independently of the primary piston 72. When the subpiston 92 moves to a position where the piston port 95b of the subpiston 92 has passed beyond the piston seal 96 as a result of the advancement of the input member 31, the primary chamber 76 is cut off from the reservoir 77 and pressurized by the input piston 93 and the subpiston 92.

Thus, even in the event of a boost failure, brake hydraulic pressure can be generated by the operation of the brake pedal 22, i.e. by the driver's pedal force, and the braking function can be maintained. At this time, the input piston 93 and the subpiston 92 generate brake hydraulic pressure by pressurizing the primary chamber 76 with the sum total area (B+C) of the pressure-receiving area C of the input piston 93 and the pressure-receiving area B of the subpiston 92. Therefore, the required brake hydraulic pressure can be generated with a moderate pressure-receiving area as compared to a case where brake hydraulic pressure is generated by only a conventional input piston having a small pressure-receiving area (e.g. the pressure-receiving area C in this embodiment), or a case where brake hydraulic pressure is generated by the input piston and the primary piston, with the entire cross-sectional area of the master cylinder used, as a pressure-receiving area. Accordingly, the pedal force and stroke of the brake pedal 22 can be appropriately adjusted.

It should foe noted that the relationship between the pressure-receiving areas A, B and C of the primary piston 72, the subpiston 22 and the input piston 93 need not necessarily be A>B>C, but may be properly set so that a desired boosted force can be obtained during normal braking, and so that the pedal force and stroke of the brake pedal 22 can be appropriately adjusted in the event of a failure.

In the electric motor-driven booster 3 according to this embodiment, the input member 31 has the input piston 93 and the plunger rod 90, which are discrete from each other, and the plunger rod 90 is axially slidably guided by the guide part 110a of the rear cover 110 secured to the rear housing member 36. In addition, the plunger rod 90 and the input rod 21 are tiltably connected through the ball joint 39. Thus, even if the input rod 21 is tilted in response to the operation of the brake pedal 22, the plunger rod 90, which is supported by the guide part 110a, does not substantially tilt.

Further, because the input piston 93 and the plunger rod 90 are discrete from, each other, even if a small tilt occurs on the input rod 21 supported by the guide part 110a, no lateral force acts on the input piston 93, or a lateral force acting on the input piston 93 is reduced. Therefore, the transmission of the lateral force to the primary piston 72 and the subpiston 92 is suppressed. Accordingly, it is possible to suppress an increase in sliding resistance of the input piston 93, the subpiston 92 and the primary piston 72, and sealing performance degradation and wear of the piston seals 81, 82, 96, 97 and 103 due to the lateral force.

In addition, because the input piston 93 and the plunger rod 90 are discrete from each other, when the electric motor-driven booster 3 and the master cylinder 2 are assembled, it is possible to connect together a master cylinder 2-side assembly incorporating the input piston 93 and a booster 3-side assembly incorporating the plunger rod 90. Accordingly, assemblability can be improved.

If should be note that, in the above-described embodiment, the input piston 93 and the plunger rod 90 may be formed integrally as one unit. In this case, however, if the plunger rod 90 guided by the guide part 110a is tilted to a small angle by a lateral force, a small tilt also occurs on the input piston 93, and consequently, the lateral force acts on the primary piston 72 and the subpiston 92. Therefore, it is desirable that the input piston 93 and the plunger rod 90 should be discrete from each other.

Further, although in the above-described embodiment the piston of the master cylinder comprises the primary piston 72 and the subpiston 92, the present invention is not limited to the described structure. The arrangement may be such that the subpiston 92 is eliminated, and that the primary piston 72 is provided with a sliding hole for the input piston 93.

Further, although in the above-described embodiment the input piston 93, which is a part of the input member, extends through the piston of the master cylinder, the present invention is not limited to the described structure. The arrangement may be such that no part of the input member extends through the piston of the master cylinder, and that the input member is abuttable against the piston of the master cylinder only in the axial direction thereof.

The electric motor-driven booster according to the embodiments can reduce a lateral force acting on the piston in the master cylinder.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2012-216305 filed on Sep. 28, 2012.

The entire disclosure of Japanese Patent Application No. 2012-216305 filed on Sep. 28, 2012 including specification, claims, drawings and summary is incorporated herein by reference in its entirety.

What is claimed is:

1. An electric motor-driven booster comprising:
a housing to which a master cylinder is connected;
an electric motor provided in the housing and configured to operate in response to an operation of a brake pedal;
a rectilinear motion member provided in the housing and driven by the electric motor to propel a piston in the master cylinder; and
an input member abuttable against the piston in the master cylinder and movable in response to the operation of the brake pedal to transmit a reaction force from brake hydraulic pressure in the master cylinder to the brake pedal;
the input member including:
a plunger rod configured to transmit the reaction force from the brake hydraulic pressure in the master cylinder; and
an input rod tiltably connected at one end thereof to the plunger rod, an other end of the input rod being connected to the brake pedal;
wherein a guide part is provided to axially movably guide the plunger rod relative to the housing.

2. The electric motor-driven booster of claim 1, wherein the input member further includes:
an input piston configured to receive the brake hydraulic pressure in the master cylinder;
the input piston and the plunger rod being discrete from each other.

3. The electric motor-driven booster of claim 1, wherein the plunger rod and the input rod are connected to each other through a ball joint.

4. The electric motor-driven booster of claim 1, further comprising:
a rear cover secured to a rear side of the housing;
the input member extending axially from an outside of the rear cover toward the master cylinder;
the guide part being provided on the rear cover.

5. The electric motor-driven booster of claim 4, wherein the rear cover has a bottom at a side thereof closer to the input rod;
the guide part being integrally provided in a center of the bottom to extend axially.

6. The electric motor-driven booster of claim 4, wherein the rear cover has a cylindrical shape;
the guide part extending to project from an opening end provided in a rear side wall of the rear cover.

7. The electric motor-driven booster of claim 1, wherein the rectilinear motion member is formed into a tubular shape;
the guide part having a cylindrical shape, the guide part being disposed to extend inside the rectilinear motion member.

8. The electric motor-driven booster of claim 1, wherein the plunger rod has a plurality of outer peripheral grooves formed on a surface thereof that is in sliding contact with the guide part.

9. The electric motor-driven booster of claim 1, wherein the plunger rod has a large-diameter flange portion formed on an intermediate part thereof, and wherein a retract position of the plunger rod is determined by abutment of the flange portion against a distal end of the guide part.

10. The electric motor-driven booster of claim 1, wherein a proximal end of the input piston abuts against a distal end of the plunger rod, and a distal end of the input piston extends into the master cylinder through a piston.

11. An electric motor-driven booster comprising:
a housing to which a master cylinder is connected;
an electric motor provided in the housing and configured to operate in response to an operation of a brake pedal to propel a piston in the master cylinder; and
an input member abuttable against the piston in the master cylinder and movable in response to the operation of the brake pedal to transmit a reaction force from brake hydraulic pressure in the master cylinder to the brake pedal;
the input member having a plunger rod pivotably connected to an input rod connected to the brake pedal to transmit the reaction force from the brake hydraulic pressure in the master cylinder;
wherein a guide part is provided to axially movably guide the plunger rod relative to the housing.

12. The electric motor-driven booster of claim 11, wherein the input member includes an input piston configured to receive the brake hydraulic pressure in the master cylinder;
the input piston, and the plunger rod being discrete from each other.

13. The electric motor-driven booster of claim 11, wherein the plunger rod and the input rod are connected to each other through a ball joint.

14. The electric motor-drivers, booster of claim 11, further comprising:
a rear cover secured to a rear side of the housing;
the input member extending axially from an outside of the rear cover toward the master cylinder;
the guide part being provided on the rear cover.

15. The electric motor-driven booster of claim 14, wherein the rear cover has a bottom at a side thereof closer to the input rod;
the guide part being integrally provided in a center of the bottom to extend, axially.

16. The electric motor-driven booster of claim 14, wherein the rear cover has a cylindrical shape;
the guide part extending to project from an opening end provided in a rear side wall of the rear cover.

17. The electric motor-driven booster of claim 11, wherein the plunger rod has a plurality of outer peripheral grooves formed on a surface thereof that is in sliding contact with the guide part.

18. The electric motor-driven booster of claim 11, wherein the plunger rod has a large-diameter flange portion formed on an intermediate part thereof, and wherein a retract position of the plunger rod is determined by abutment of the flange portion against a distal end of the guide part.

19. The electric motor-driven booster of claim 11, wherein a proximal end of the input piston abuts against a distal end of the plunger rod, and a distal end of the input piston extends into the master cylinder through a piston.

20. An electric motor-driven booster comprising:
a housing to which a master cylinder is connected;
an electric motor provided in the housing and configured to operate in response to an operation of a brake pedal;
a rectilinear motion member provided in the housing and driven by the electric motor to propel a piston in the master cylinder; and
an input member abuttable against the piston in the master cylinder and movable in response to the operation of the brake pedal to transmit a reaction force from brake hydraulic pressure in the master cylinder to the brake pedal;
the input member including:
a plunger rod configured to transmit the reaction force from the brake hydraulic pressure in the master cylinder;
an input rod tiltably connected, at one end thereof to the plunger rod, an other end of the input rod being connected to the brake pedal; and
an input piston configured to receive the brake hydraulic pressure in the master cylinder;
wherein a tubular guide part is provided in the housing, the guide part extending in an axial direction of the master cylinder and having the plunger rod extending therethrough.
